(19) United States
(12) Patent Application Publication
(10) Pub. No.: US 2024/0063471 A1
(43) Pub. Date: Feb. 22, 2024

(54) Cooling Device Having a Heat Sink and Intermediate Cooling Elements, Electrical Energy Store and Motor Vehicle

(71) Applicant: Bayerische Motoren Werke Aktiengesellschaft, Muenchen (DE)

(72) Inventor: Torsten FRANKE, Muenchen (DE)

(21) Appl. No.: 18/271,690

(22) PCT Filed: Feb. 15, 2022
(86) PCT No.: PCT/EP2022/053654

§ 371 Date: Jul. 11, 2023

(30) Foreign Application Priority Data
Mar. 15, 2021 (DE) 10 2021 106 200.4

(51) Int. Cl. H01M 10/6568; H01M 10/625; H01M 10/613; H01M 50/213; H01M 50/375

(52) U.S. Cl. CPC H01M 10/6568; H01M 10/625; H01M 10/613; H01M 50/213; H01M 50/375; H01M 2220/20

(57) ABSTRACT

A cooling device for an electrical energy store, having a heat sink for arranging on one side of a cell assembly formed of energy storage cells of the electrical energy store and for cooling the energy storage cells is provided. The heat sink has openings for aligned arrangement so as to form degassing elements of the energy storage cells. The openings form a degassing duct for a hot gas of the energy storage cells that leaks via the degassing elements. The cooling device has intermediate cooling elements for arranging in clearances of the cell assembly between the energy storage cells in order to compensate for a loss of cooling surface that results from the openings of the heat sink. The intermediate cooling elements are arranged on the heat sink and are designed to dissipate waste heat from the energy storage cells to the heat sink.

### BACKGROUND AND SUMMARY OF THE INVENTION

The invention relates to a cooling device for an electrical energy store, having a heat sink for arrangement on one side of a cell array formed from energy storage cells of the electrical energy store and for cooling the energy storage cells. The heat sink has openings for the aligned arrangement with venting elements of the energy storage cells, wherein the openings form a venting channel for a hot gas from the energy storage cells which escapes via the venting elements. The invention moreover relates to an electrical energy store and to a motor vehicle.

There is presently a focus on electrical energy stores which can be used, for example, as traction batteries for electrified motor vehicles, i.e., electric or hybrid vehicles. Such electrical energy stores usually have a cell array consisting of a plurality of interconnected energy storage cells. In order to cool the energy storage cells, it is known from the prior art to arrange a heat sink on one side of the cell array. In addition, the energy storage cells usually have venting elements via which a hot gas which forms in a cell housing of an energy storage cell in the event of a fault can escape from the cell housing. Where the heat sink is arranged on the side of the cell array on which the venting elements are located, it can, as disclosed in German patent document DE 10 2017 219 176 A1, have openings which are arranged so that they are aligned with the venting elements. These openings form respective venting channels via which the hot gas from the respective energy storage cell can escape. However, these openings have the disadvantage that a cooling surface area of the heat sink is reduced.

An object of the present invention is to provide efficient cooling for energy storage cells of an electrical energy store.

This object is achieved according to the invention by a cooling device, an electrical energy store, and a motor vehicle having the features according to the respective independent patent claims. Advantageous embodiments of the invention are the subject of the dependent patent claims, the description, and the FIGURE.

A cooling device according to the invention for an electrical energy store has a heat sink for arrangement on one side of a cell array formed from energy storage cells of the electrical energy store and for cooling the energy storage cells. The heat sink has openings for the aligned arrangement with venting elements of the energy storage cells, wherein the openings form a venting channel for a hot gas from the energy storage cells which escapes via the venting elements. Furthermore, the cooling device for compensating a loss of cooling surface area resulting from the openings of the heat sink has intermediate cooling elements for arrangement in free spaces of the cell array between the energy storage cells. The intermediate cooling elements are arranged on the heat sink and are designed to emit waste heat from the energy storage cells to the heat sink.

Also part of the invention is an electrical energy store with at least one cell array including energy storage cells and a cooling device according to the invention, wherein the heat sink is arranged on a side of the cell array which has the venting elements, and wherein the intermediate cooling elements are arranged in free spaces between the energy storage cells and extend at least partially along cell housing sidewalls of the energy storage cells. The electrical energy store can be, for example, a rechargeable traction battery which can be designed as a high-voltage energy store. The electrical energy store moreover has a store housing in which the at least one cell array is arranged. The energy storage cells can be designed, for example, as prismatic energy storage cells or pouch cells. The energy storage cells are preferably designed as round cells. The energy storage cells here have a cell housing with a venting element, for example, a bursting membrane, via which a hot gas which forms in the cell housing in the event of a fault can escape. The cell housings have a cell housing base, a cell housing cover, and the cell housing sidewalls. In the case of a round cell, the cell housing bases and the cell housing covers have a circular design and the cell housing sidewalls are designed as cylindrical shell surfaces. The venting elements are preferably formed in the cell housing bases and hence arranged on an underside of the cell array.

In order to discharge the waste heat from the energy storage cells, the cooling device has the heat sink which is designed in particular as a heat sink through which coolant can flow. The heat sink is designed in particular in the form of a plate and is arranged on the underside of the cell array on which the venting elements of the energy storage cells are arranged, and hence on the cell housing bases. In other words, the energy storage cells are arranged so that they stand on the heat sink. Because the venting elements of the energy storage cells are arranged on the same side as the heat sink, the heat sink has the openings or holes which are arranged on the venting elements. These openings form the venting channels.

However, the cooling surface area provided by the heat sink, and hence a cooling efficiency provided by the heat sink, are reduced by these openings. In order to compensate this loss of cooling surface area, the cooling device has the intermediate cooling elements which extend between the energy storage cells and are arranged at least partially along the cell housing sidewalls. The intermediate cooling elements enable heat transfer between the cell housing sidewalls to the heat sink to which the intermediate cooling elements are thermally coupled. For example, the intermediate cooling elements can be designed as metal ribs or cooling fins protruding from a surface of the heat sink. The intermediate cooling elements can be designed as a single piece with the heat sink or be connected mechanically and thermally to the heat sink. The intermediate cooling elements can project into the free spaces which are formed in the case of round cells between the round cells because of their cylindrical shape. The intermediate cooling elements extend in particular only over part of the height of the energy storage cells.

Such a cooling device with a heat sink in which venting channels are formed and with intermediate cooling elements enables reliable bleeding of hot gas from the cell array and good cooling efficiency.

It has proved to be advantageous if the heat sink through which the coolant can flow is a double-walled storage enclosure lower part of the storage enclosure of the electrical energy store. The storage enclosure has the storage enclosure lower part or a storage enclosure base, and a storage enclosure upper part or a storage enclosure cover. The storage enclosure lower part and the storage enclosure upper part can be mechanically connected in order to close off an enclosure interior in which the at least one cell array is arranged. The heat sink is formed by the double-walled storage enclosure lower part in which the openings are formed. The storage enclosure lower part can be attached, for example, to a coolant-conducting cooling circuit of the motor vehicle. The cooling device has a particularly space-saving design by virtue of the storage enclosure lower part being designed as a heat sink. Moreover, the hot gas from a venting energy storage cell can be bled through the venting channels in the storage enclosure lower part from the storage enclosure and into the surroundings of the energy store.

The cooling device preferably has closure elements which cover the openings in the heat sink when there is no hot gas present and which are designed to fail to act when the hot gas is present in order to open the venting channel. The closure elements are particularly advantageous if the heat sink is formed by the storage enclosure lower part. By virtue of the closure elements, it can be ensured that the storage enclosure is sealed to the outside when there is no hot gas present. The closure elements are arranged in particular on a side of the heat sink which faces the surroundings. The closure elements are designed, for example, as bursting membranes or points at which a break is intended to occur because the material is weakened in a surface of the heat sink. In particular, the closure elements are formed by an insulating layer with which the, for example, metal heat sink is coated in order to electrically insulate the metal cell housings.

In an advantageous embodiment of the invention, the intermediate cooling elements are designed as thermally conductive ribs protruding from a surface of the heat sink and which are designed to at least partially enclose the cell housing sidewalls in order to absorb the waste heat and to absorb forces acting on the electrical energy store, for example, as a consequence of an accident. The intermediate cooling elements thus serve additionally to increase the stability of the electrical energy store. The intermediate cooling elements can, for example, form a receptacle for the energy storage cells and completely surround the cell housing of the energy storage cells along an outer periphery of the cell housing.

Also part of the invention is a motor vehicle with at least one electrical energy store according to the invention. The motor vehicle is designed in particular as an electrically powered motor vehicle in the form of a car.

The embodiments presented with reference to the cooling device according to the invention and their advantages apply correspondingly for the electrical energy store according to the invention and for the motor vehicle according to the invention.

Further features of the invention can be found in the claims, the FIGURE, and the description of the FIGURE. The features and combinations of features mentioned above in the description, and the features and combinations of features mentioned below in the description of the FIGURE and/or shown solely in the FIGURE can be used not only in the respective specified combination but also in other combinations or on their own.

The invention will now be explained in detail with the aid of a preferred exemplary embodiment and with reference to the drawing.

### BRIEF DESCRIPTION OF THE DRAWINGS

FIG. 1 shows a schematic illustration of an embodiment of an electrical energy store 1.

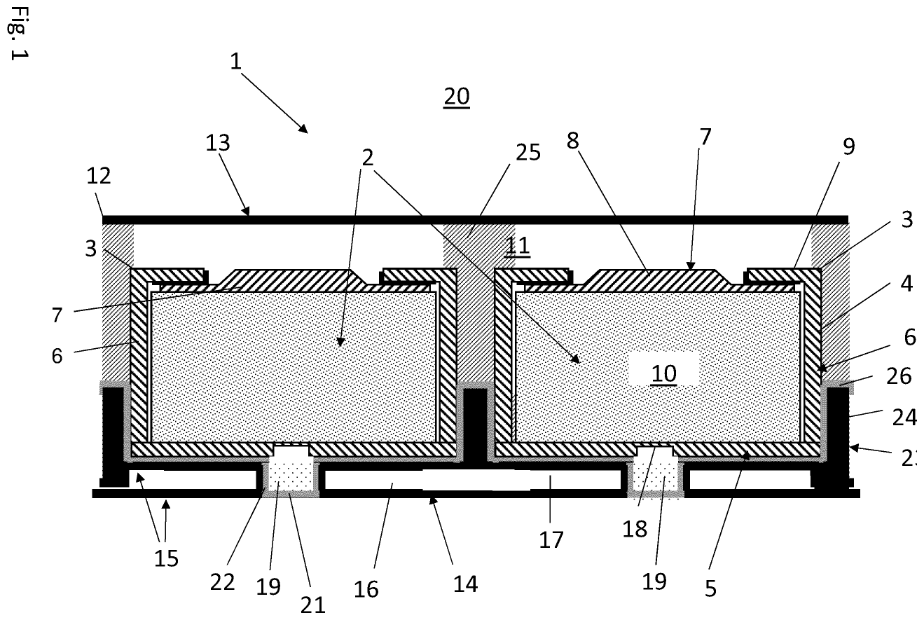

### DETAILED DESCRIPTION OF THE DRAWINGS

The electrical energy store 1 has a cell array 2 consisting of interconnected energy storage cells 3. The energy storage cells 3 can be designed, for example, as round cells. The energy storage cells 3 have a cell housing 4 with a cell housing base 5, cell housing sidewalls 6, and a cell housing cover 7. Cell terminals 8,9, via which the energy storage cells 3 can be connected by means of cell connectors which are not shown here, are formed on the cell housing cover 7. A galvanic element 10 of the energy storage cell 3 is arranged inside the cell housing 4. The cell array 2 is arranged in an enclosure interior 11 of a storage enclosure 12 of the electrical energy store 1. The storage enclosure 12 here has a storage enclosure upper part 13 and a storage enclosure lower part 14 which are mechanically connected to each other in order to close off the housing interior 11. The storage enclosure 12 is formed in particular from a metal, for example steel.

The electrical energy store 1 has a cooling device 15 in order to cool the energy storage cells 3 during operation of the electrical energy store 1. The cooling device 15 has a heat sink 16. The heat sink 16 is arranged on an underside, formed by the cell housing bases 5, of the cell array 2 and thus cools the energy storage cells 3 from below. The heat sink 16 is formed by the storage enclosure lower part 14 which for this purpose has a double-walled design and thus comprises an intermediate space 17 for the passage of a flowing coolant. The intermediate space 17 can be joined to a cooling circuit in which the coolant circulates.

The cell housings 4 have venting elements 18 which are arranged in the cell housing bases 5 and via which a hot gas which forms in the cell housing 4 can escape from the cell housing 4, for example, in the case of a short-circuit inside the cell. However, because the heat sink 16 is arranged on the cell housing bases 5, it has openings 19 which form a venting channel, passing through the heat sink 16, for the hot gas. Because the heat sink 16 is formed by the storage enclosure lower part 14, the hot gas can escape through the venting channel into surroundings 20 of the electrical energy store 1. The openings 19 are covered on the side of the surroundings 20 by closure elements 21 in order to seal off the housing interior 11 when the hot gas is not present. The closure elements 21 can open the venting channel when the hot gas is present in order to allow pressure equalization between the housing interior 11 and the surroundings 20. The closure elements 21 can be configured, for example, as potting compound which expands in the case of elevated pressure in the cell, as weakened material of the storage enclosure lower part 14, as a membrane, or as a combination thereof. The membrane can also be formed by an electrical insulating layer 22 which covers an upper side, facing the cell array 2, of the heat sink 16 or of the storage enclosure lower part 14, and an inner side of the venting channels and which electrically disconnects the cell housing 4 from the heat sink 16 or the storage enclosure lower part 14.

A cooling surface area provided by the heat sink 16 is reduced by the openings 19. The cooling device 15 therefore has intermediate cooling elements 23 which are arranged between the energy storage cells 3. The intermediate cooling elements extend along the cell housing sidewalls 6 over part of the cell housing height and at least partially enclose the cell housing sidewalls 6. The intermediate cooling elements 23 are designed as thermally conductive ribs 24 made from a metal. The ribs 24 are connected to the heat sink 16 in a form-fitting fashion or metallurgically, with good heat conductance. These intermediate cooling elements 23 increase heat transfer between the energy storage cells 3 and the heat sink 16 and (over)compensate the loss of cooling surface area. In a preferred embodiment, the thermally conductive ribs 24 form a directly connected extension of a frame 25 for the energy storage cells 3 which surrounds the energy storage cells 3 in some regions and to which the energy storage cells 3 can be connected, for example, adhesively bonded. The frame 25 can be connected, for example, adhesively bonded, to the storage enclosure 12. The ribs 24 thus contribute to absorbing forces acting on the cell array 2. In a particularly preferred embodiment, a transition 26 between the frame 25 and the thermally conductive ribs 24 has an undulating or indented configuration in order to homogenize the local amplitudes of laterally acting forces.

1.-9. (canceled)

10. A cooling device for an electrical energy store, having a heat sink arranged on one side of a cell array formed from energy storage cells of the electrical energy store and configured to cool the energy storage cells, wherein the heat sink has openings for an aligned arrangement with venting elements of the energy storage cells, wherein the openings form a venting channel for a hot gas from the energy storage cells which escapes via the venting elements, wherein the cooling device is configured to compensate for a loss of cooling surface area resulting from the openings of the heat sink with intermediate cooling elements arranged in free spaces of the cell array between the energy storage cells, the intermediate cooling elements being arranged on the heat sink and designed to discharge waste heat from the energy storage cells to the heat sink.

11. The cooling device according to claim 10, wherein the heat sink is a heat sink through which a coolant can flow.

12. The cooling device according to claim 11, wherein the heat sink through which the coolant can flow is a double-walled storage enclosure lower part of a storage enclosure of the electrical energy store.

13. The cooling device according to claim 10, wherein the cooling device has closure elements which cover the openings in the heat sink when there is no hot gas present and which are designed to fail to act when the hot gas is present in order to open the respective venting channel.

14. The cooling device according to claim 10, wherein the intermediate cooling elements are designed as thermally conductive ribs protruding from a surface of the heat sink and which are designed to at least partially enclose the cell housing sidewalls in order to absorb the waste heat and to absorb forces acting on the electrical energy store.

15. The cooling device according to claim 11, wherein the cooling device has closure elements which cover the openings in the heat sink when there is no hot gas present and which are designed to fail to act when the hot gas is present in order to open the respective venting channel.

16. The cooling device according to claim 12, wherein the cooling device has closure elements which cover the openings in the heat sink when there is no hot gas present and which are designed to fail to act when the hot gas is present in order to open the respective venting channel.

17. The cooling device according to claim 11, wherein the intermediate cooling elements are designed as thermally conductive ribs protruding from a surface of the heat sink and which are designed to at least partially enclose the cell housing sidewalls in order to absorb the waste heat and to absorb forces acting on the electrical energy store.

18. The cooling device according to claim 12, wherein the intermediate cooling elements are designed as thermally conductive ribs protruding from a surface of the heat sink and which are designed to at least partially enclose the cell housing sidewalls in order to absorb the waste heat and to absorb forces acting on the electrical energy store.

19. The cooling device according to claim 13, wherein the intermediate cooling elements are designed as thermally conductive ribs protruding from a surface of the heat sink and which are designed to at least partially enclose the cell housing sidewalls in order to absorb the waste heat and to absorb forces acting on the electrical energy store.

20. An electrical energy store with at least one cell array including energy storage cells and a cooling device according to claim 10, wherein the heat sink is arranged on a side of the at least one cell array which has the venting elements and the intermediate cooling elements are arranged in free spaces between the energy storage cells and extend at least partially along cell housing sidewalls of the energy storage cells.

21. The electrical energy store according to claim 15, wherein the venting elements are formed on an underside, formed by cell housing bases of the energy storage cells, of the at least one cell array and the heat sink is arranged on the underside of the at least one cell array.

22. The electrical energy store according to claim 15, wherein the energy storage cells are designed as round cells.

23. The electrical energy store according to claim 15, wherein the heat sink is a heat sink through which a coolant can flow.

24. The electrical energy according to claim 15, wherein the heat sink through which the coolant can flow is a double-walled storage enclosure lower part of a storage enclosure of the electrical energy store.

25. The electrical energy according to claim 15, wherein the cooling device has closure elements which cover the openings in the heat sink when there is no hot gas present and which are designed to fail to act when the hot gas is present in order to open the respective venting channel.

26. The electrical energy according to claim 15, wherein the intermediate cooling elements are designed as thermally conductive ribs protruding from a surface of the heat sink and which are designed to at least partially enclose the cell housing sidewalls in order to absorb the waste heat and to absorb forces acting on the electrical energy store.

27. A motor vehicle with at least one electrical energy store according to claim 15.
